(19) United States
(12) Patent Application Publication
(10) Pub. No.: US 2026/0238846 A1
(43) Pub. Date: Aug. 13, 2026

(54) STREAMING 2D WEB CONTENT TO A BROWSER-BASED 3D ENVIRONMENT

(71) Applicant: FMR LLC, Boston, MA (US)

(72) Inventor: Hangyu Wang, Cary, NC (US)

(21) Appl. No.: 19/051,664

(22) Filed: Feb. 12, 2025

(51) Int. Cl. H04N 21/431; G06F 3/04815; G06F 16/955

(52) U.S. Cl. CPC H04N 21/4312; G06F 3/04815; G06F 16/955

(57) ABSTRACT

Methods and apparatuses for streaming 2D web content to a browser-based 3D environment include a server that establishes a bidirectional connection with a web browser of a client device and detects a streaming request event from the client device, including an embedded content URL. The server activates a headless browser to render the embedded content for transmission in a video stream to the client device, where the video stream is displayed as a texture on a 3D object. The server detects a user input event from the client device corresponding to a user interaction with the video stream. The server translates the user input event in the headless browser to simulate the user interaction and cause an update to the embedded content. The server renders the updated embedded content for transmission in the video stream to the client device.

### TECHNICAL FIELD

This application relates generally to methods and apparatuses, including computer program products, for streaming two-dimensional (2D) web content to a browser-based three-dimensional (3D) environment.

### BACKGROUND

Generally, web content embedding allows websites to display external content (such as video or audio media made available by remote resources or other web servers) without uploading or hosting it directly on the website. Traditional web content embedding technologies, such as iframes, are limited to two-dimensional, flat representations and often come with cross-origin restrictions that limit the integration of third-party content. Additionally, these types of web content embedding technologies do not provide a secure, isolated environment for displaying external web content.

### SUMMARY

Therefore, what is needed are methods and systems that provide an immersive virtual environment for users to view and interact with embedded web content, i.e., a third-party webpage or content file, while also isolating the client browser window and client device from direct code execution of the third-party embedded web content. Advantageously, the techniques described herein provide for the streaming of embedded third-party web content to a browser-based 3D environment—e.g., a 3D object rendered in the local browser software—in real time using a bidirectional connection between server and client.

The methods and systems described herein beneficially provide for the following technical improvements over existing web content embedding technologies:
The systems and methods include a server-side headless browser that visits and renders a desired 2D webpage. The visual output is captured as a video stream, which is then transmitted over a bidirectional connection to the client's browser software.
On the client side, a 3D environment is rendered in a local browser window, where the streamed video of the 2D webpage is textured onto a 3D object, allowing the user to view and interact with the 2D webpage as part of the 3D scene.
User interactions with the 3D object displaying the 2D content are captured and sent back to the server, where they are translated into real interactions on the webpage rendered by the headless browser. This allows users to navigate and interact with the 2D webpage in real-time, as though they were directly interacting with a traditional 2D browser window.

The invention, in one aspect, features a system for streaming two-dimensional (2D) web content to a browser-based three-dimensional (3D) environment. The system includes a server computing device having a memory for storing computer-executable instructions and a processor that executes the computer-executable instructions. The server computing device establishes a bidirectional connection between the server computing device and a web browser of a client computing device upon receiving a webpage load event from the client computing device. The server computing device detects a streaming request event transmitted on the bidirectional connection by the web browser of the client computing device, the streaming request event comprising a URL of embedded content in the webpage. The server computing device activates a headless browser to navigate to the URL and render the embedded content for transmission in a video stream to the client computing device over the bidirectional connection, where the web browser on the client computing device displays the video stream as a texture on a 3D object in the webpage. The server computing device detects a user input event transmitted on the bidirectional connection by the web browser of the client computing device, the user input event corresponding to an interaction performed by a user of the client computing device with the video stream displayed in the webpage. The server computing device translates the user input event in the headless browser to simulate the interaction performed by the user with the video stream and cause an update to the embedded content. The server computing device renders the updated embedded content for transmission in the video stream to the client computing device over the bidirectional connection.

The invention, in another aspects, features a computerized method of streaming two-dimensional (2D) web content to a browser-based three-dimensional (3D) environment. A server computing device establishes a bidirectional connection between the server computing device and a web browser of a client computing device upon receiving a webpage load event from the client computing device. The server computing device detects a streaming request event transmitted on the bidirectional connection by the web browser of the client computing device, the streaming request event comprising a URL of embedded content in the webpage. The server computing device activates a headless browser to navigate to the URL and render the embedded content for transmission in a video stream to the client computing device over the bidirectional connection, where the web browser on the client computing device displays the video stream as a texture on a 3D object in the webpage. The server computing device detects a user input event transmitted on the bidirectional connection by the web browser of the client computing device, the user input event corresponding to an interaction performed by a user of the client computing device with the video stream displayed in the webpage. The server computing device translates the user input event in the headless browser to simulate the interaction performed by the user with the video stream and cause an update to the embedded content. The server computing device renders the updated embedded content for transmission in the video stream to the client computing device over the bidirectional connection.

Any of the above aspects can include one or more of the following features. In some embodiments, the bidirectional connection comprises a WebSocket connection. In some embodiments, the embedded content comprises 2D video content. In some embodiments, the server computing device transmits the video stream to the client computing device using a WebRTC connection.

In some embodiments, the user input event comprises a mouse click event, a mouse move event, a key press event, or a physical movement of the user as captured by an extended reality (XR) apparatus coupled to the client computing device. In some embodiments, the web browser on the client computing device comprises a transparent layer that is configured to capture user input events for transmission to the server computing device via the bidirectional connection. In some embodiments, when the user input event comprises a mouse click event, the transparent layer captures a set of coordinates corresponding to a position of a cursor in the web browser and determines whether the set of coordinates intersect a position of the 3D object in the webpage. In some embodiments, when the user input event comprises a physical movement of the user, the transparent layer captures a set of 3D coordinates corresponding to the physical movement, translates the set of 3D coordinates into a set of 2D coordinates, and determines whether the set of 2D coordinates intersect a position of the 3D object in the webpage.

In some embodiments, the 3D object in the webpage comprises a curved surface on which the video stream is displayed. In some embodiments, the web browser generates the curved surface based upon one or more dimensions of the video stream. In some embodiments, the one or more dimensions comprise an aspect ratio of the video stream.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for streaming 2D web content to a browser-based 3D environment.

FIG. 2 is a flow diagram of a computerized method of streaming 2D web content to a browser-based 3D environment.

FIG. 3 is a diagram of an exemplary webpage displayed in a host browser that includes a curved 3D screen for rendering the video stream.

FIG. 4 is a diagram of exemplary Javascript code for implementing the 3D mapping algorithm.

FIG. 5 is a diagram of exemplary Javascript code for handling a mouse click event.

FIG. 6 is a diagram of exemplary Javascript code for handling a mouse move event.

FIG. 7 is a diagram of exemplary Javascript code for handling an XR movement event.

FIG. 8 is a diagram of an exemplary user interface for displaying an augmented reality (AR) environment with a browser window and an embedded 3D object.

FIG. 9 is a diagram of an exemplary user interface for displaying a virtual reality (VR) environment that includes an embedded 3D object.

### DETAILED DESCRIPTION

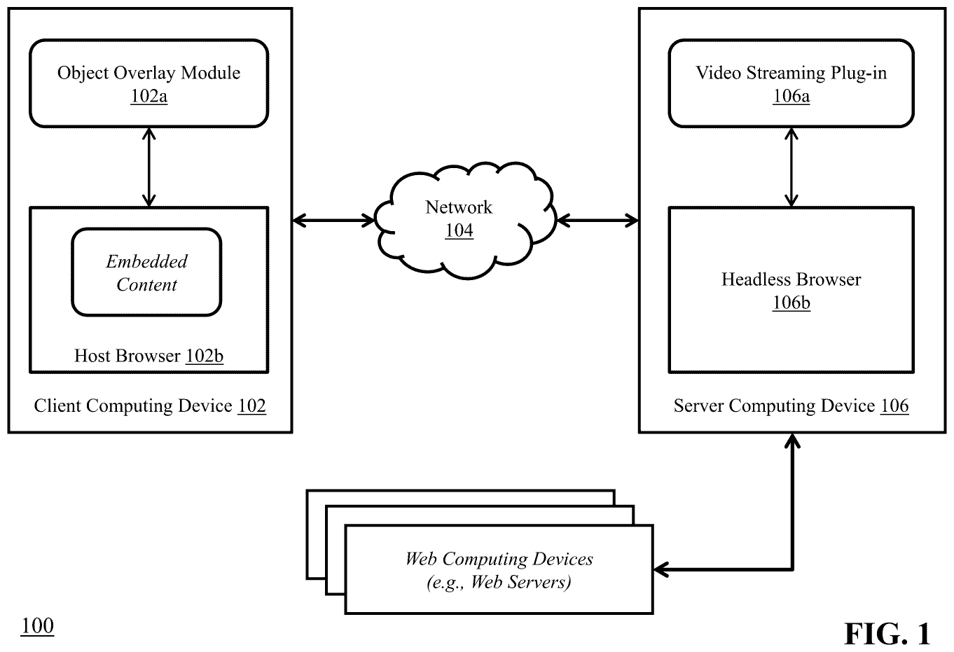

FIG. 1 is a block diagram of system 100 for streaming 2D web content to a browser-based 3D environment. System 100 includes client computing device 102 with object overlay module 102a and host browser 102b, communication network 104, and server computing device 106 with video streaming plug-in 106a and headless browser 106b.

Client computing device 102 connects to one or more communications networks (e.g., network 104) in order to communicate with server computing device 106 to provide input and receive output relating to the process of streaming 2D web content to a browser-based 3D environment as described herein. Exemplary client computing devices 102 include but are not limited to desktop computers, laptop computers, tablets, mobile devices, smartphones, extended reality (XR) devices, and the like.

For example, in some embodiments, client computing device 102 comprises a 3D viewing device/apparatus (e.g., headset, goggles, glasses, etc.) that enables a user to view a 3D virtual environment (such as a virtual reality (VR) environment, an augmented reality (AR) environment, a mixed reality (MR) environment, and/or an extended reality (XR) environment). Exemplary 3D viewing devices can include, but are not limited to, the Meta Quest 3™ available from Meta Platforms, Inc., the Apple® Vision Pro™ available from Apple, Inc., and the HTC Vive XR Elite™ available from HTC Corp. As can be appreciated, the 3D viewing device can comprise browser software (e.g., host browser 102b) than enables a user of the 3D viewing device to see and interact with webpages and related content received from remote computing devices, such as server computing device 106 and/or other web-based computing devices.

Further, the 3D viewing device can be coupled to one or more control device(s) that enable a user wearing the 3D viewing device to interact with the 3D virtual environment being rendered and displayed to the user. For example, a control device can be an apparatus such as a joystick, keypad, haptic controller, glove, and the like that the user holds and manipulates to provide input to client computing device 102 for interaction with the 3D environment-including manipulation of objects within the environment. In this context, the user can provide input in many ways, including but not limited to performing gestures with the control device, pressing one or more buttons on the control device, moving the control device in relation to objects in the 3D environment, or any combination of the above. In some embodiments, the user can hold a plurality of control devices (e.g., a joystick in each hand) to provide input to client computing device 102. It should be appreciated that other types of client computing devices that are capable of connecting to the components of the system 100 can be used without departing from the scope of invention. Although FIG. 1 depicts one client computing device 102, it should be appreciated that system 100 can include any number of client computing devices.

Client computing device 102 is configured with browser software (i.e., host browser 102b), which enables client computing device 102 to establish a communication session with server computing device 106 via network 104. For example, a user at client computing device 102 can launch host browser 102b and enter a Uniform Resource Locator (URL) that points to web content. In some embodiments, the URL is an address that refers to the location of a server computing device (e.g., server 106) on the Internet. Host browser 102b on client computing device 102 establishes a connection with the server location identified in the URL via communications network 104 and the server provides the requested content. Exemplary host browser 102b software includes, but is not limited to, Chrome™ from Google, Inc., Microsoft® Edge available from Microsoft Corporation, Safari™ available from Apple, Inc., Mozilla® Firefox available from Mozilla Corporation, and/or Meta Quest Browser™ available from Meta Platforms, Inc. Client computing device 102 also includes object overlay module 102a. In some embodiments, object overlay module 102a is integrated with host browser 102b software to provide functions relating to streaming 2D web content to a browser-based 3D environment as will be described in greater detail throughout the specification.

Communications network 104 enables client computing device 102 to communicate with server computing device 106. Network 104 is typically comprised of one or more wide area networks, such as the Internet and/or a cellular network, and/or local area networks. In some embodiments, network 104 is comprised of several discrete networks and/or sub-networks (e.g., cellular to Internet).

Server computing device 106 is a device including specialized hardware and/or software modules that execute on one or more processors and interact with one or more memory modules of computing device 106, to receive data from other components of system 100, transmit data to other components of system 100, and perform functions for streaming 2D web content to a browser-based 3D environment as described herein. As mentioned above, server computing device 106 includes video streaming plug-in 106a and headless browser 106b that execute on one or more processors of server computing device 106. In some embodiments, software 106a and 106b are specialized sets of computer software instructions programmed onto one or more dedicated processors in server computing device 106 and can include specifically designated memory locations and/or registers for executing the specialized computer software instructions.

Although software 106a and 106b is shown in FIG. 1 as executing within a single server computing device 106, in some embodiments the functionality of software 106a and 106b can be distributed among a plurality of computing devices. As shown in FIG. 1, server computing device 106 enables software 106a and 106b to communicate with each other in order to exchange data for the purpose of performing the described functions. It should be appreciated that any number of computing devices, arranged in a variety of architectures, resources, and configurations (e.g., networked computing, cluster computing, virtual computing, cloud computing) can be used without departing from the scope of the technology described herein. Exemplary functionality of software 106a and 106b is described in detail below.

In some embodiments, server computing device 106 is coupled to one or more web-based computing devices (e.g., web servers) that can provide web content requested by a user of client computing device 102. A user at client computing device 102 can transmit a request for web content to server computing device 106 via host browser 102b, where the request references web content made available by a remote web server. For example, the user may provide a URL associated with video content available at YouTube™ (www.youtube.com). Upon receiving the request, server computing device 106 can establish a connection to a web server identified in the URL that hosts the requested video content and render the corresponding content in headless browser 106b. In some embodiments, the rendered content includes both the video content and the surrounding webpage provided by YouTube™. In other embodiments, the rendered content includes just the video content. It should be appreciated that other types of web content can be received by server computing device 106 for rendering in headless browser 106b without limiting the scope of technology described herein.

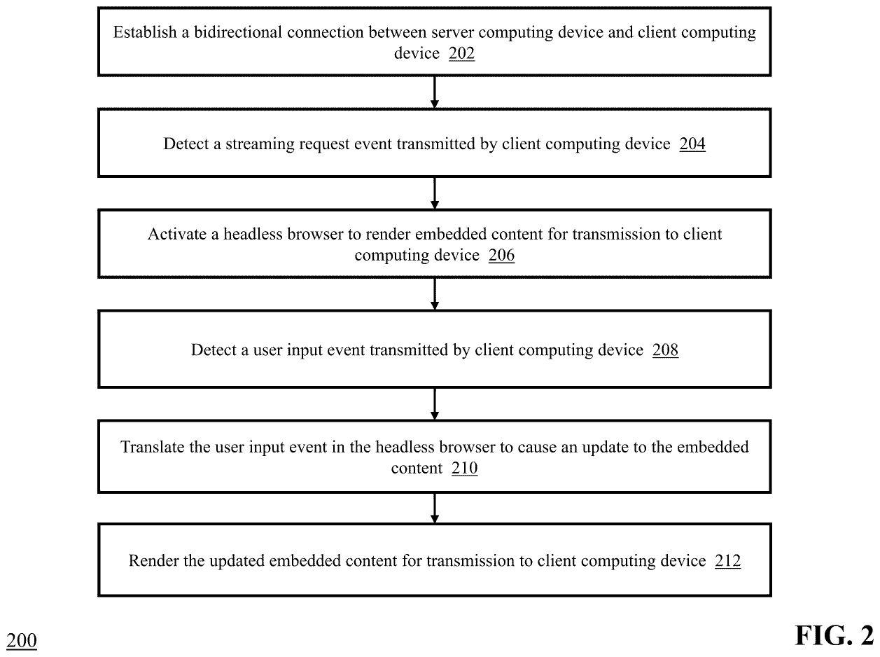

FIG. 2 is a flow diagram of a computerized method 200 of streaming 2D web content to a browser-based 3D environment, using system 100 of FIG. 1. Server computing device 106 establishes (step 202) a bidirectional connection between server computing device 106 and a web browser (i.e., host browser 102b) of client computing device 102 upon receiving a webpage load event from client computing device 102. As described previously, a user of client computing device 102 can interact with browser software (i.e., host browser 102b) that is installed locally on client computing device 102. For example, the user can provide input to host browser 102b in the form of a URL referencing a webpage made available by server computing device 106, where the webpage itself includes embedded 3D content that is hosted by another computing device, such as a remote web server coupled to server computing device 106. In this scenario, the webpage can include an embedded URL that points to a location of the video content hosted by the remote web server. In some embodiments, the webpage can include programmatic instructions for rendering the embedded video content on client computing device 102, as will be described in greater detail below.

Upon loading the webpage, host browser 102b transmits a request to server computing device 106 for establishing a connection with server 106. In some embodiments, the request informs server computing device 106 that client computing device 102 wants to establish a WebSocket connection with server computing device 106. Upon completing the connection handshake via HTTP, server computing device 106 accepts the WebSocket connection request from client computing device 102 and establishes a WebSocket connection with client computing device 102. Generally, the WebSocket protocol enables bidirectional, full duplex, stateful communication between client and server over a single Transmission Control Protocol (TCP) connection. Advantageously, the bidirectional nature of the WebSocket protocol enables the streaming of 2D web content from headless browser 106b of server computing device 106 to a 3D environment rendered at host browser 102b of client computing device 102, as described in detail throughout the specification. Once the WebSocket connection is established between server computing device 106 and client computing device 102, server computing device 106 begins listening for events from client computing device 102.

Server computing device 106 detects (step 204) a streaming request event transmitted on the bidirectional connection by the web browser (i.e., host browser 102b) of client computing device 102. As mentioned above, the webpage requested by host browser 102b includes an embedded URL that points to content hosted by another computing device. An example is video content hosted by YouTube™, where the embedded URL points to a specific video content page at youtube.com. When host browser 102b processes the initial webpage and encounters the embedded URL, host browser 102b transmits a streaming request event to server computing device 106 via the established WebSocket connection. The streaming request event includes the embedded URL encountered by host browser 102b during loading of the initial webpage. For example, the streaming request event can instruct server computing device 106 to start streaming the content referenced in the embedded URL to host browser 102b.

When server computing device 106 receives the streaming request event from client computing device 102, server computing device 106 activates (step 206) headless browser 106b to navigate to the URL (i.e., the embedded URL in the streaming request event) and render the embedded content in headless browser 106b for transmission in a video stream to client computing device 102 over the bidirectional connection. Generally, and without limitation, headless browser 106b comprises web browser software that does not have a graphical user interface (GUI). Instead, headless browser 106b provides automated control of the web page rendered in the browser based upon commands received from client computing device 102 via the bidirectional connection. In this example, server computing device 106 launches an instance of headless browser 106b, navigates to a web server using the embedded URL received from client computing device 102, receives content from the web server, and renders content corresponding to the embedded URL in headless browser 106b.

Upon rendering the web content in headless browser 106b, server computing device 106 generates a video stream containing the web content displayed in headless browser 106b to client computing device 102. Server computing device 106 invokes video streaming plug-in 106a to generate and transmit the video stream to client computing device 102. In some embodiments, video streaming plug-in 106a comprises a plug-in (or extension) for headless browser 106b that is configured to capture the content of headless browser 106b. For example, video streaming plug-in 106a can be created using Puppeteer (available at pptr.dev and described at developer.chrome.com/docs/puppeteer) to capture the content in headless browser 106b and listen for/act on page interaction events received from client computing device 102.

In some embodiments, video streaming plug-in 106a is configured to transmit the video stream to client computing device 102 by establishing a WebRTC connection with host browser 102b of client computing device 102. Generally, and without limitation, the WebRTC standard (webrtc.org) includes an API that enables real-time streaming of data (e.g., video/audio) to and/or from a web browser. Video streaming plug-in 106a can establish a WebRTC connection with host browser 102a of client computing device 102 and transmit the captured content from headless browser 102a to host browser 102a for display to the user of client computing device 102. In some embodiments, video streaming plug-in 106a uses the WebSocket connection between server 106 and client 102 to handle the signaling for establishing the WebRTC connection.

In some embodiments, host browser 102b receives the video stream from video streaming plug-in 106a and displays the video stream in the webpage of host browser 102b. As mentioned above, the video stream corresponds to an embedded URL in the initial webpage loaded by host browser 102b. In some embodiments, host browser 102b can display the video stream in a portion of the initial webpage that corresponds to the embedded URL, i.e., an HTML element. The HTML element can include programmatic instructions that defines how host browser 102b displays the video stream. In some embodiments, the HTML element comprises a WebXR element that maps the 2D video stream as a texture on a 3D object in host browser 102b. Exemplary WebXR frameworks used by host browser 102b to render the 3D object include, but are not limited to the A-Frame web framework (available at aframe.io) and the three.js JavaScript library (available at threejs.org).

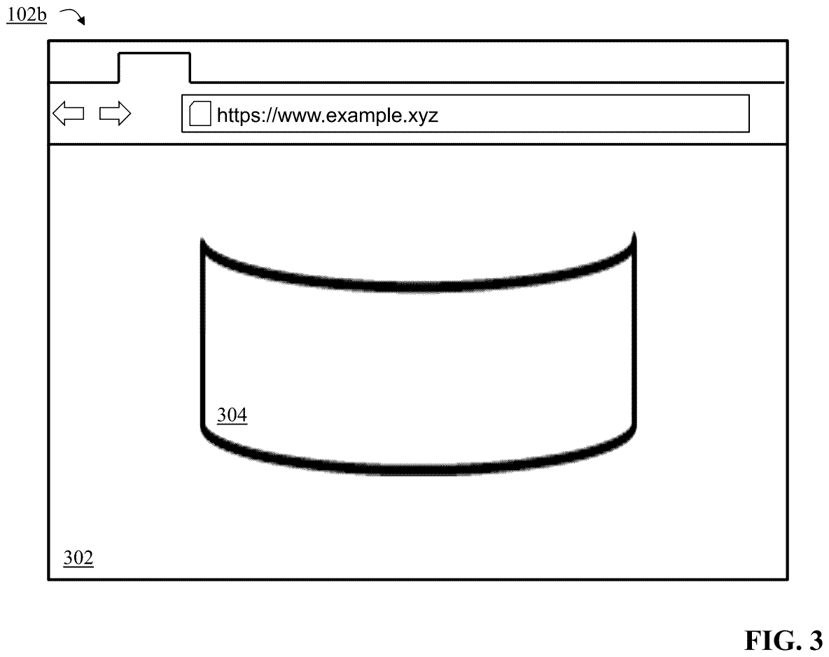

As one example, the 3D object rendered by host browser 102a is a curved object, such as a curved screen for displaying the video stream from server computing device 106. FIG. 3 is a diagram of an exemplary webpage 302 displayed in host browser 102b that includes a curved 3D screen 304 for rendering the video stream received from server computing device 106. An important consideration when mapping the video stream as a texture onto a curved 3D screen is to maintain the aspect ratio of the video stream. To map the video stream to a curved screen while maintaining the aspect ratio, client computing device 102 should ensure that the curved portion of the 3D object represents the same aspect ratio as the video stream. In this example, the curved screen can be generated using a 3D cylinder which is a primitive 3D shape in most available 3D libraries or game engines.

An algorithm for mapping the video stream onto a curved surface of a 3D cylinder is provided below. In this algorithm, the video width is denoted as videoWidth and the video height is denoted as videoHeight. The aspect ratio (aspectRatio) of the video stream is then given by:

$$aspectRatio = \frac{videoWidth}{videoHeight}$$

For a cylinder, the width of the curved screen (the arc length) is a portion of the circumference of the cylinder. The full circumference of the cylinder is calculated using the formula:

$$circumference = 2 π \times radius$$

The arc length, which represents the width of the screen, should match the aspect ratio of the video. This arc length is a part of the full circumference and is calculated by the formula:

$$arcLength = thetaLength \times radius$$

To maintain the aspect ratio, this arc length should be proportional to the video width, while the height of the cylinder (which corresponds to the video height) is fixed. Therefore, the following proportion should hold true:

$$\frac{arcLength}{cylinderHeight} = aspectRatio$$

Substituting in the arc length equation above results in the following:

$$\frac{thetaLength \times radius}{cylinderHeight} = aspectRatio$$

Therefore, thetaLength can be determined by rearranging the equation as follows:

$$thetaLength = \frac{aspectRatio \times cylinderHeight}{radius}$$

Now, substituting aspectRatio with videoWidth/videoHeight results in the following equation:

$$thetaLength = \frac{( \frac{videoWidth \times cylinderHeight}{videoHeight} )}{radius}$$

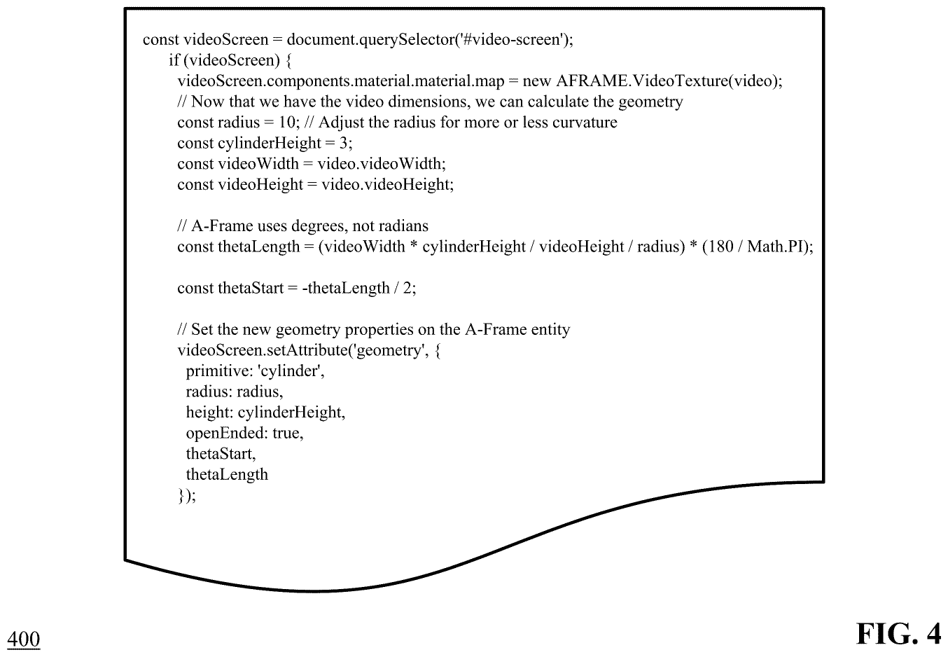

FIG. 4 is a diagram of exemplary Javascript code 400 for A-Frame for implementing the above-described 3D mapping algorithm.

After rendering of the 3D object and mapping of the video stream has been performed by host browser 102b, the user at client computing device 102 can view the requested 2D web content in a 3D format for a more immersive user experience. The user can then interact with the video stream displayed on the 3D object just as they would with a traditional 2D webpage—e.g., using an implement connected to client computing device 102 such as a mouse or touchpad to click buttons, images, or links, or to hover over content. In some embodiments, the user can enter text into a text field displayed in the embedded content using a keyboard connected to client computing device 102. In some embodiments, the user can interact with the 3D object using an XR apparatus. For example, the user can perform one or more actions or movements in 3D space (e.g., gestures, head movements) that are captured by the XR apparatus and transmitted to headless browser 106b at server computing device 106.

As can be appreciated, the HTML element (in A-Frame or three.js) that displays the 3D object can also display a 3D cursor that can be controlled by a user input device (mouse, keyboard, touchpad, XR apparatus) coupled to client computing device 102. In order to handle user input events for the 3D object rendered in the webpage displayed by host browser 102b, client computing device 102 is configured with object overlay module 102a which generates a transparent overlay that is placed on top of the 3D object area in the webpage displayed by host browser 102b. When the user manipulates the 3D cursor to interact with the 3D object and/or HTML element in the host browser 102b webpage, the transparent overlay captures the user input events (and corresponding metadata for the events) and transmits the events to headless browser 106a via the WebSocket connection for processing.

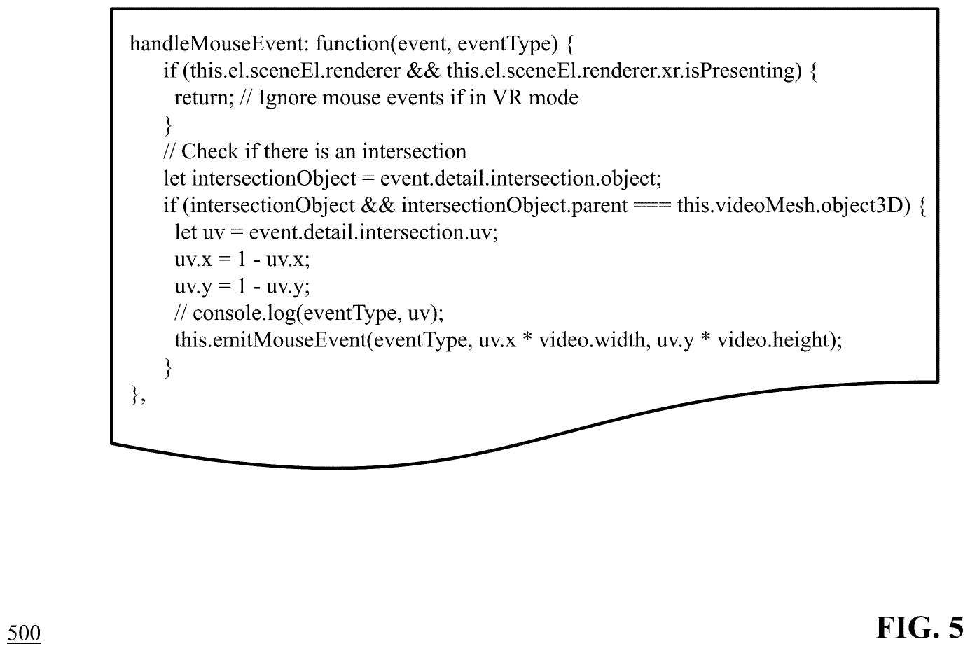

For mouse click events, the HTML element includes callback functions for these events that are invoked when a corresponding mouse click event is detected by the transparent overlay. Using one example, the A-Frame web framework includes ‘mousedown’ and ‘mouseup’ callbacks for the 3D cursor. When handling those events, object overlay module 102a checks whether there is an intersection between the 3D cursor and the 3D object mesh in the 3D scene (e.g., does the position of the 3D cursor in the transparent overlay overlap with the 3D object displayed in host browser 102b). If so, object overlay module 102a calculates the UV coordinates (also known as texture coordinates) of the intersection point on the 3D object video mesh. The UV coordinates represent the normalized 2D texture coordinates on the 3D object's surface. The UV range is [0, 1]. As the video texture is on the inner side of the cylinder, object overlay module 102a inverts the UV coordinates by subtracting them from 1. Then, object overlay module 102a determines the cursor position on the 2D video by multiplying the UV coordinates by the video dimensions. FIG. 5 is a diagram of exemplary Javascript code 500 for A-Frame for handling a mouse click event.

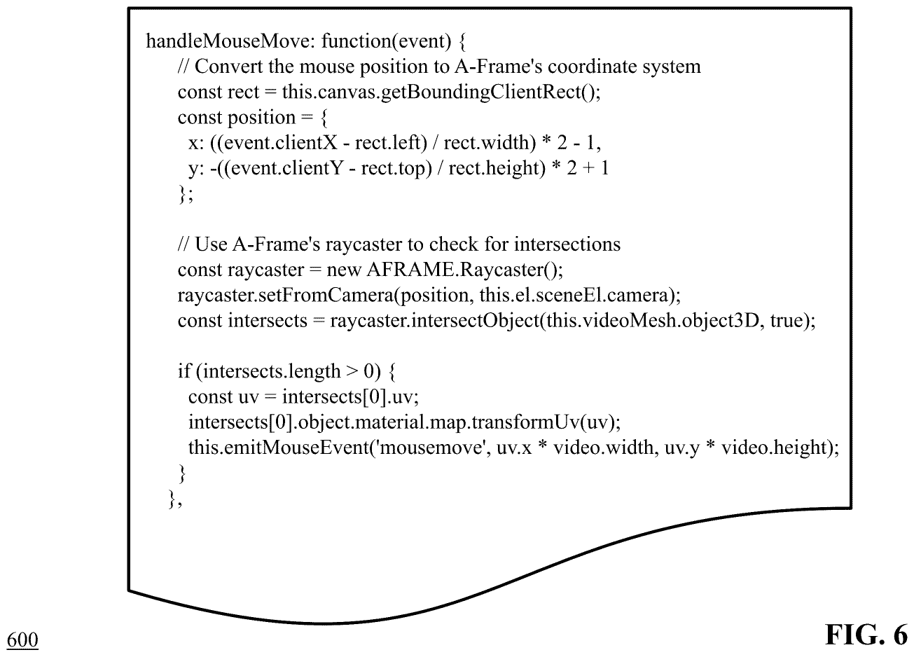

Handling mouse move events is a bit more complex in the A-Frame based implementation, because A-Frame does not capture mouse move events for the 3D cursor. However, the 3D scene is just a big HTML canvas which does catch mouse move events. Object overlay module 102a uses the A-Frame based raycaster to cast a ray from the camera to the mouse position and check whether the cursor intersects the 3D object video mesh. FIG. 6 is a diagram of exemplary Javascript code 600 for A-Frame for handling a mouse move event.

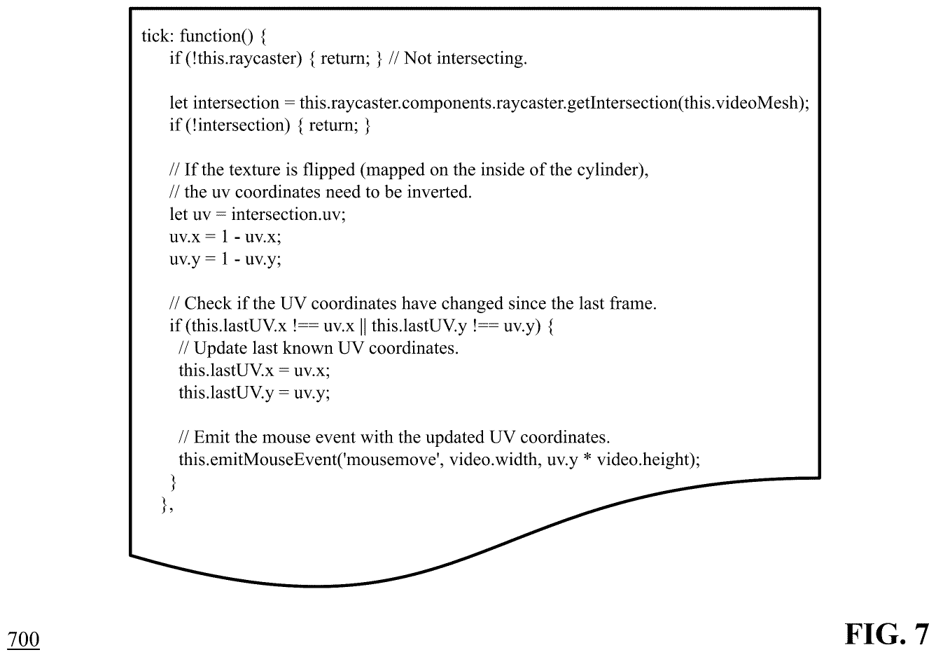

User input events from an XR apparatus can also be handled by object overlay module 102a. Controller(s) of an XR apparatus typically emit ‘triggerdown’ and ‘triggerup’ events, which are similar to the ‘mousedown’ and ‘mouseup’ events described above. For cursor movements, however, there is typically no corresponding ‘triggermove’ event. As a result, object overlay module 102a can take advantage of the tick( ) method, which is a special lifecycle method that is defined in a component registered using AFRAME.registerComponent( ). The tick( ) method is called on every frame or animation tick of the scene, providing a way to update the component's state or perform any necessary operations based on the current frame. FIG. 7 is a diagram of exemplary Javascript code 700 for A-Frame for handling an XR movement event.

Upon detecting any of the above user interaction event types, object overlay module 102a transmits the event type and the cursor position to server computing device 106 via the WebSocket connection. Server computing device 106 detects (step 208) the user input events transmitted on the bidirectional connection by the web browser (i.e., host browser 102b) of client computing device 102. As described above, each user input event corresponds to an interaction performed by the user of client computing device 102 with the video stream as displayed in the webpage of host browser 102a as a texture on a 3D object mesh. Server computing device 106 processes each of the events to simulate the actions performed by the user on the webpage displayed in headless browser 106.

In some embodiments, server computing device 106 translates (step 210) the user input event in the headless browser to simulate the interaction performed by the user with the video stream and cause an update to the embedded content. Generally, each user input event includes a user input event type (e.g., mousedown, mouseup, mousemove, triggerdown, triggerup, triggermove, etc.) and metadata associated with the user event. Examples of metadata include, but are not limited to, x-y coordinates of the 3D pointer on the embedded content (i.e., the 3D object mesh) and a timestamp of the user input event. Server computing device 106 can convert the x-y coordinates received in the user input event from a first coordinate system (i.e., the 3D coordinate system associated with the 3D object mesh) to a second coordinate system (i.e., the 2D coordinate system associated with the webpage displayed in headless browser 106b). Then, based upon the user input event type, server computing device 106 can trigger a corresponding event in headless browser 106b to simulate the user input performed at the client computing device 102. As one example, when the user input event is a mousedown or mouseup event, server computing device 106 can initiate a mousedown or mouseup event at the same location on the webpage displayed in headless browser 106 using the converted x-y coordinates.

The initiated event(s) can result in one or more updates to the embedded content. In the case of video content being displayed to the user of client computing device 102, clicking on the video content during playback may cause the video playback to pause. In this example, when server computing device 106 triggers a corresponding mouse click event, headless browser 106b renders (step 212) the updated embedded content (i.e., the webpage in headless browser 106b) to show that the video content has been paused. As a result, video streaming plugin 106a transmits the updated webpage to client computing device 102 as part of the video stream. Upon receiving the portion of the video stream that corresponds to the updated webpage, client computing device 102 displays the updated webpage to the user of client computing device 102, who sees that playback of the video content is paused.

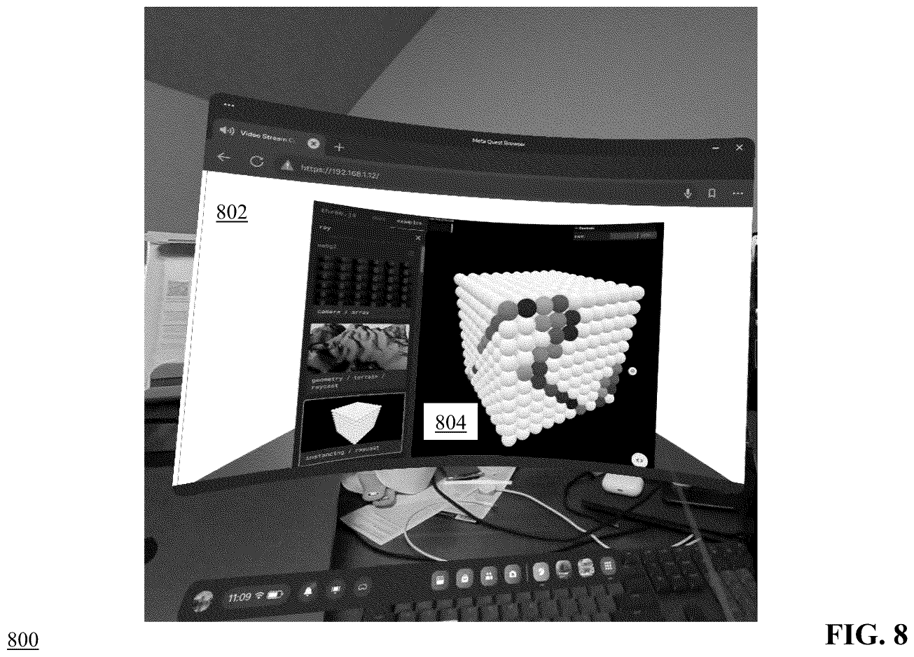

FIG. 8 is a diagram of an exemplary user interface 800 generated by client computing device 102 for displaying an augmented reality (AR) environment that includes browser window 802 with an embedded 3D object 804. In the example of FIG. 8, client computing device 102 is a 3D viewing device/apparatus (e.g., headset, goggles, glasses, etc.) with host browser software 102b that is configured to generate browser window 802 as a hologram overlay displayed on top of the user's surrounding physical environment. Browser window 802 displays a first website that includes 3D object 804 embedded within the web page. As shown, 3D object 804 displays a video stream received from server computing device 106 as described above, where the video stream includes a different website. 3D object 804 comprises a curved surface on which the video stream is displayed. The user of client computing device 102 can interact with 3D object 804 in the AR environment, which can result in an update to the website displayed in 3D object 804 as described previously.

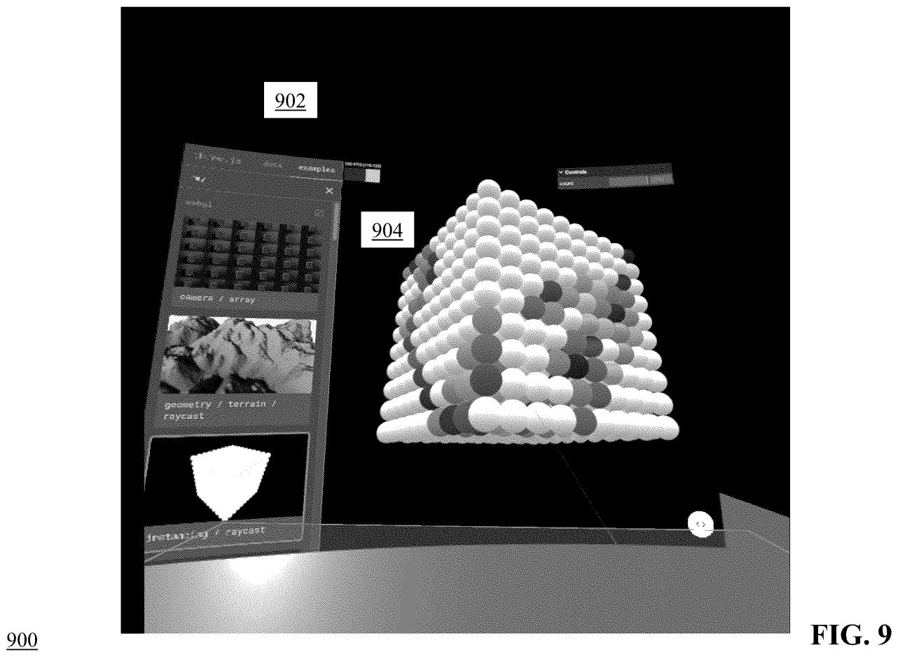

FIG. 9 is a diagram of an exemplary user interface 900 generated by client computing device 102 for displaying a virtual reality (VR) environment 902 that includes embedded 3D object 904. In the example of FIG. 9, client computing device 102 is a 3D viewing device/apparatus (e.g., headset, goggles, glasses, etc.) with host software (e.g., browser 102b or other software) that is configured to generate the VR environment 902. The VR environment 902 displays 3D object 904 embedded within the environment 902. As shown, 3D object 904 displays a video stream received from server computing device 106 as described above, where the video stream includes a website. 3D object 904 comprises a curved surface on which the video stream is displayed. The user of client computing device 102 can interact with 3D object 904 in the VR environment 902, which can result in an update to the website displayed in 3D object 904 as described previously. In some embodiments, client computing device 102 is configured to switch between the AR environment of FIG. 8 and the VR environment of FIG. 9 upon receiving input from the user of client computing device 102.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account-which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for streaming two-dimensional (2D) web content to a browser-based three-dimensional (3D) environment, the system comprising a server computing device having a memory for storing computer-executable instructions and a processor that executes the computer-executable instructions to:
establish a bidirectional connection between the server computing device and a web browser of a client computing device upon receiving a webpage load event from the client computing device;
detect a streaming request event transmitted on the bidirectional connection by the web browser of the client computing device, the streaming request event comprising a URL of embedded content in the webpage;
activate a headless browser to navigate to the URL and render the embedded content for transmission in a video stream to the client computing device over the bidirectional connection, wherein the web browser on the client computing device displays the video stream as a texture on a 3D object in the webpage;
detect a user input event transmitted on the bidirectional connection by the web browser of the client computing device, the user input event corresponding to an interaction performed by a user of the client computing device with the video stream displayed in the webpage;
translate the user input event in the headless browser to simulate the interaction performed by the user with the video stream and cause an update to the embedded content; and
render the updated embedded content in the video stream to the client computing device over the bidirectional connection.

2. The system of claim 1, wherein the bidirectional connection comprises a WebSocket connection.

3. The system of claim 2, wherein the embedded content comprises 2D video content.

4. The system of claim 3, wherein the server computing device transmits the video stream to the client computing device using a WebRTC connection.

5. The system of claim 1, wherein the user input event comprises a mouse click event, a mouse move event, a key press event, or a physical movement of the user as captured by an extended reality (XR) apparatus coupled to the client computing device.

6. The system of claim 5, wherein the web browser on the client computing device comprises a transparent layer that is configured to capture user input events for transmission to the server computing device via the bidirectional connection.

7. The system of claim 6, wherein when the user input event comprises a mouse click event, the transparent layer captures a set of coordinates corresponding to a position of a cursor in the web browser and determines whether the set of coordinates intersect a position of the 3D object in the webpage.

8. The system of claim 6, wherein when the user input event comprises a physical movement of the user, the transparent layer captures a set of 3D coordinates corresponding to the physical movement, translates the set of 3D coordinates into a set of 2D coordinates, and determines whether the set of 2D coordinates intersect a position of the 3D object in the webpage.

9. The system of claim 1, wherein the 3D object in the webpage comprises a curved surface on which the video stream is displayed.

10. The system of claim 9, wherein the web browser generates the curved surface based upon one or more dimensions of the video stream.

11. The system of claim 10, wherein the one or more dimensions comprise an aspect ratio of the video stream.

12. A computerized method of streaming two-dimensional (2D) web content to a browser-based three-dimensional (3D) environment, the method comprising:
establishing, by a server computing device, a bidirectional connection with a web browser of a client computing device upon receiving a webpage load event from the client computing device;
detecting, by the server computing device, a streaming request event transmitted on the bidirectional connection by the web browser of the client computing device, the streaming request event comprising a URL of embedded content in the webpage;
activating, by the server computing device, a headless browser to navigate to the URL and render the embedded content for transmission in a video stream to the client computing device over the bidirectional connection, wherein the web browser on the client computing device displays the video stream as a texture on a 3D object in the webpage;
detecting, by the server computing device, a user input event transmitted on the bidirectional connection by the web browser of the client computing device, the user input event corresponding to an interaction performed by a user of the client computing device with the video stream displayed in the webpage;
translating, by the server computing device, the user input event in the headless browser to simulate the interaction performed by the user with the video stream and cause an update to the embedded content; and
rendering, by the server computing device, the updated embedded content in the video stream to the client computing device over the bidirectional connection.

13. The method of claim 12, wherein the bidirectional connection comprises a WebSocket connection.

14. The method of claim 13, wherein the embedded content comprises 2D video content.

15. The method of claim 14, wherein the server computing device transmits the video stream to the client computing device using a WebRTC connection.

16. The method of claim 12, wherein the user input event comprises a mouse click event, a mouse move event, a key press event, or a physical movement of the user as captured by an extended reality (XR) apparatus coupled to the client computing device.

17. The method of claim 16, wherein the web browser on the client computing device comprises a transparent layer that is configured to capture user input events for transmission to the server computing device via the bidirectional connection.

18. The method of claim 17, wherein when the user input event comprises a mouse click event, the transparent layer captures a set of coordinates corresponding to a position of a cursor in the web browser and determines whether the set of coordinates intersect a position of the 3D object in the webpage.

19. The method of claim 17, wherein when the user input event comprises a physical movement of the user, the transparent layer captures a set of 3D coordinates corresponding to the physical movement, translates the set of 3D coordinates into a set of 2D coordinates, and determines whether the set of 2D coordinates intersect a position of the 3D object in the webpage.

20. The method of claim 12, wherein the 3D object in the webpage comprises a curved surface on which the video stream is displayed.

21. The method of claim 20, wherein the web browser generates the curved surface based upon one or more dimensions of the video stream.

22. The method of claim 21, wherein the one or more dimensions comprise an aspect ratio of the video stream.
